(19) United States
(12) Patent Application Publication
(10) Pub. No.: US 2025/0121569 A1
(43) Pub. Date: Apr. 17, 2025

(54) Composite Structure with Bend Through Web and Number of Flanges

(71) Applicant: The Boeing Company, Arlington, VA (US)

(72) Inventors: Brian Gregory Robins, Renton, WA (US); Steven Joseph Plummer, Seattle, WA (US); Kurtis Shuldberg Willden, Kent, WA (US)

(21) Appl. No.: 18/678,971

(22) Filed: May 30, 2024

Related U.S. Application Data
(60) Provisional application No. 63/590,272, filed on Oct. 13, 2023.

(51) Int. Cl. B29C 70/44; B29C 70/08; B29C 70/16; B29C 70/54

(52) U.S. Cl. CPC B29C 70/44; B29C 70/088; B29C 70/16; B29C 70/54

(57) ABSTRACT

Methods and apparatus for forming a composite structure with a bend in a web and a number of flanges of the composite structure are presented. A flat uncured composite laminate is placed in contact with a forming surface of a mandrel. Pressure is applied to a portion of the flat uncured composite laminate over a kink region in the forming surface of the mandrel to form a bent laminate. The bent laminate and the mandrel are placed into a forming assembly. Overhanging portions of the bent laminate are bent into contact with sides of the mandrel by the forming assembly to form the composite structure, the composite structure having the bend in a web of the composite structure in contact with the forming surface of the mandrel and a number of flanges in contact with the sides of the mandrel.

### CROSS-REFERENCE TO RELATED APPLICATION

This application claims the benefit of U.S. Provisional Patent Application Ser. No. 63/590,272, filed Oct. 13, 2023, and entitled “Composite Structure with Bend Through Web and Number of Flanges,” which is incorporated herein by reference in its entirety.

### BACKGROUND INFORMATION

### 1. Field

The present disclosure relates generally to composite manufacturing and more specifically to forming a composite structure with a bend through a web and a number of flanges.

### 2. Background

Composite materials are strong, light-weight materials created by combining two or more functional components. For example, a composite material may include reinforcing fibers bound in polymer resin matrix. The fibers can take the form of a unidirectional tape, woven cloth or fabric, or a braid. The mechanical properties and other material properties of composite materials can be desirable for some implementations.

Composite manufacturing uses different methods than metal processing due to the different material characteristics. Some composite manufacturing is performed by hand due to complex shapes, especially shapes with bends or kinks. However, it is undesirably time consuming to form composite structures by hand.

Therefore, it would be desirable to have a method and apparatus that takes into account at least some of the issues discussed above, as well as other possible issues. It would be desirable to have an automated method of forming a composite structure with a bend with reduced wrinkles.

### SUMMARY

An embodiment of the present disclosure provides a method of forming a composite structure with a bend in a web and a number of flanges of the composite structure. A flat uncured composite laminate is placed in contact with a forming surface of a mandrel. Pressure is applied to a portion of the flat uncured composite laminate over a kink region in the forming surface of the mandrel to form a bent laminate. The flat uncured composite laminate comprises a plurality of zero degree plies discontinuous along a respective length. The bent laminate and the mandrel are placed into a forming assembly. Overhanging portions of the bent laminate are bent into contact with sides of the mandrel by the forming assembly to form the composite structure, the composite structure having the bend in a web of the composite structure in contact with the forming surface of the mandrel and number of flanges in contact with the sides of the mandrel.

An embodiment of the present disclosure provides a forming system. The forming system comprises a mandrel comprising a web surface with a kink region and flange forming surfaces on either side of the web surface, the flange forming surfaces connected to the web surface by two corner forming edges.

An embodiment of the present disclosure provides a method of forming a composite structure with a bend in a web and a number of flanges of the composite structure. A bent laminate comprising a plurality of composite plies on a mandrel is moved into a forming assembly, the bent laminate in contact with a web surface of the mandrel and comprising overhanging portions overhanging the mandrel, the web surface comprising a kink region comprising a number of kinks forming an angle between a first section and a second section of the web surface in a longitudinal direction of the mandrel. The bent laminate comprises a plurality of zero degree plies having cuts within a desired distance of each kink of the number of kinks. The overhanging portions of the bent laminate are bent into contact with sides of the mandrel by the forming assembly to form the composite structure, the composite structure having the bend in a web of the composite structure in contact with the forming surface of the mandrel and number of flanges in contact with the sides of the mandrel.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a flowchart of a method of forming a composite structure with a bend in accordance with an illustrative embodiment;

FIG. 4 is a flowchart of a method of forming a composite structure with a bend in a web and a number of flanges of the composite structure in accordance with an illustrative embodiment;

FIG. 5 is an illustration of an isometric view of a composite structure with a number of bends in accordance with an illustrative embodiment;

FIG. 6 is an illustration of an isometric view of a mandrel with a number of kinks in accordance with an illustrative embodiment;

FIG. 7 is an illustration of an isometric view of a mandrel with a number of kinks and a flat uncured composite charge in accordance with an illustrative embodiment;

FIG. 8 is an illustration of an underside of an overhanging portion of a flat uncured composite charge on a mandrel with a number of kinks in accordance with an illustrative embodiment;

FIG. 9 is an illustration of a side view of a presser foot in contact with the flat uncured composite charge over the number of kinks of the mandrel in accordance with an illustrative embodiment;

FIG. 10 is an illustration of an isometric view of a shim in contact with the bent composite charge on the mandrel in accordance with an illustrative embodiment;

FIG. 11 is an illustration of the bent composite charge on the mandrel being introduced into the forming assembly in accordance with an illustrative embodiment;

FIG. 12 is an illustration of an urging device of the forming assembly in accordance with an illustrative embodiment;

FIG. 13 is an illustration of a heater assembly of the forming assembly in accordance with an illustrative embodiment;

FIG. 14 is an illustration of an isometric view of a composite structure with a number of bends in accordance with an illustrative embodiment;

FIGS. 15A and 15B are a flowchart of a method of forming a composite structure with a bend in a web and a number of flanges of the composite structure in accordance with an illustrative embodiment;

FIG. 16 is a flowchart of a method of forming a composite structure with a bend in a web and a number of flanges of the composite structure in accordance with an illustrative embodiment;

FIG. 17 is an illustration of an aircraft manufacturing and service method in a form of a block diagram in accordance with an illustrative embodiment; and

FIG. 18 is an illustration of an aircraft in a form of a block diagram in which an illustrative embodiment may be implemented.

### DETAILED DESCRIPTION

The illustrative examples recognize and take into account one or more considerations. The illustrative examples recognize and take into account that a bend is present in wing spars for aerospace structure and drag reduction. The illustrative examples recognize and take into account that the bend poses manufacturing challenges for composite fabrication. The illustrative examples recognize and take into account that some spars with bends are manufactured in three or more components.

The illustrative examples allow uncured composite charges to be kinked without undesirable formation of wrinkling in the green composite charge. The illustrative examples provide methods and an apparatus for forming a composite structure with at least one bend.

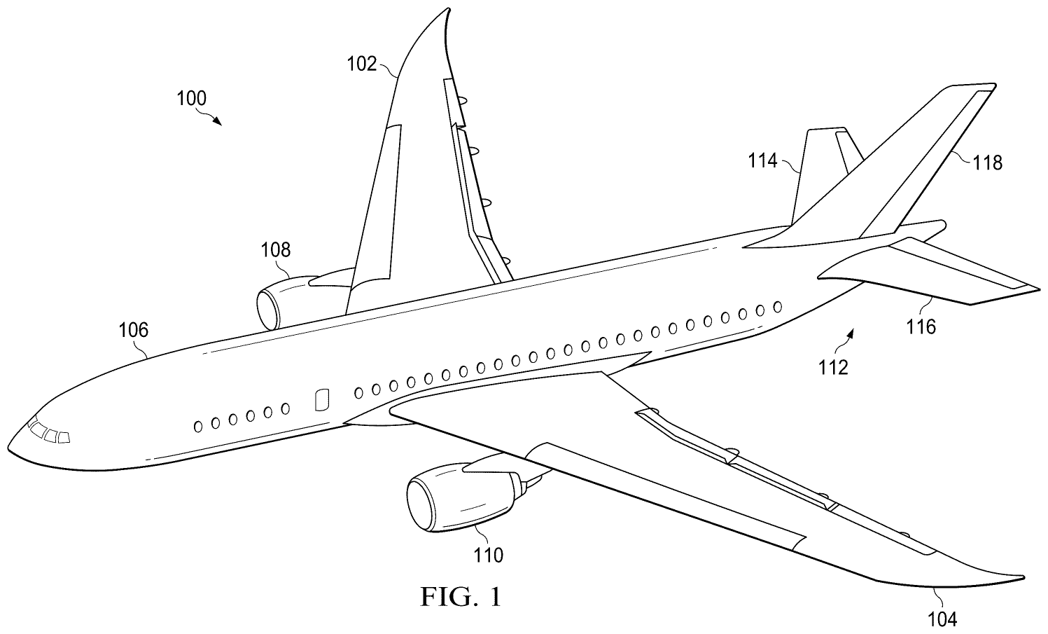

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite structures formed using the illustrative examples. For example, components of at least one of wing 102 or wing 104 can be formed using the illustrative examples. In some illustrative examples, spars of at least one of wing 102 or wing 104 can be formed using the illustrative examples.

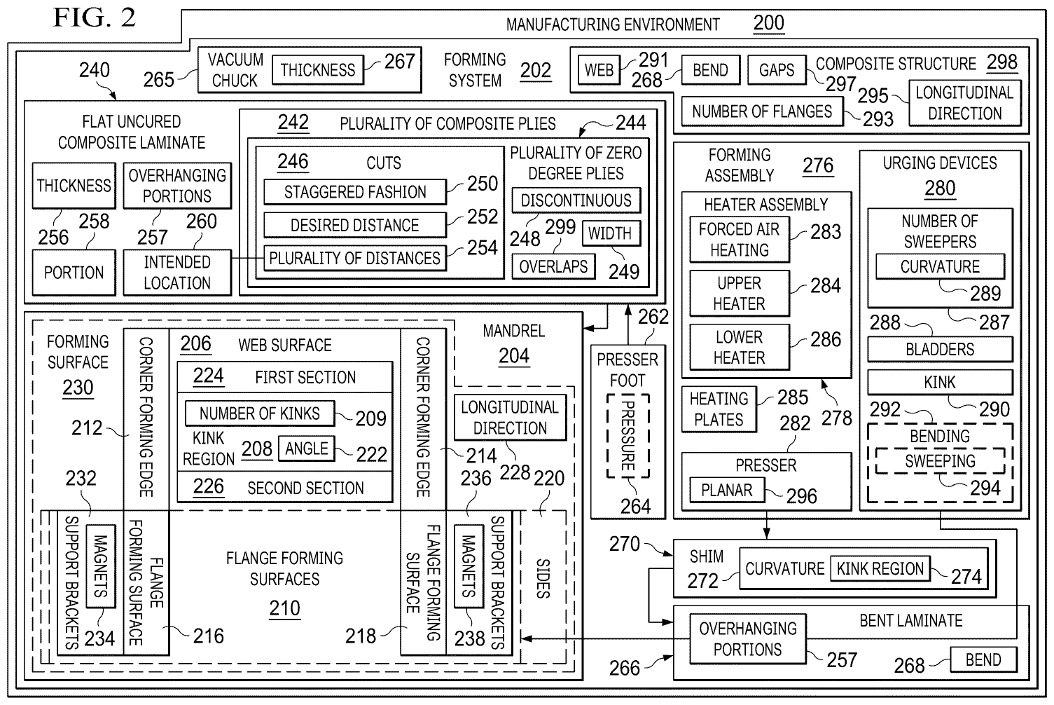

Turning now to FIG. 2, an illustration of a block diagram of a manufacturing environment is depicted in accordance with an illustrative embodiment. Forming system 202 is present in manufacturing environment 200. In some illustrative examples, forming system 202 can be referred to as a composite forming system, a spar forming system, or a longitudinal composite forming system. Forming system 202 comprises mandrel 204. Mandrel 204 comprises web surface 206 with kink region 208 and flange forming surfaces 210 on either side of web surface 206. Flange forming surfaces 210 are connected to web surface 206 by two corner forming edges, corner forming edge 212 and corner forming edge 214. Flange forming surfaces 210 comprise flange forming surface 216 connected to web surface 206 by corner forming edge 212. Flange forming surfaces 210 comprise flange forming surface 218 connected to web surface 206 by corner forming edge 214. Web surface 206, flange forming surface 216 and flange forming surface 218 form forming surface 230 of mandrel 204. Sides 220 of mandrel 204 comprise flange forming surfaces 210. Web surface 206 comprises kink region 208 comprising number of kinks 209 forming angle 222 between first section 224 and second section 226 of web surface 206 in longitudinal direction 228 of mandrel 204. In some illustrative examples, number of kinks 209 comprises more than one kink configured to form bend 268 in composite structure 298. In some other illustrative examples, number of kinks 209 is a single kink configured to form bend 268 in composite structure 298.

In some illustrative examples, forming system 202 comprises support brackets, support brackets 236 and support brackets 232, movably connected to flange forming surfaces 210 of mandrel 204. Support brackets 236 are movably connected to flange forming surface 218. Support brackets 232 are movably connected to flange forming surface 216.

Support brackets 236 and support brackets 232 can be movably connected to flange forming surface 216 by at least one of an active or passive connection. In some illustrative examples, support brackets, support brackets 236 and support brackets 232, are connected to flange forming surface 216 by vacuum cups, hydraulics, or other forces. In some illustrative examples, the support brackets, support brackets 236 and support brackets 232, are magnetically connected to flange forming surfaces 210. The magnetic connection can be passive or active. In some illustrative examples, support brackets 236 and support brackets 232, are movably connected to flange forming surface 216 by electronic magnets that vary in strength based on electricity supplied. As depicted, support brackets 236 are connected to flange forming surface 218 by magnets 238. As depicted, support brackets 232 are connected to flange forming surface 216 by magnets 234.

Support brackets 236 and support brackets 232 support overhanging portions 257 of flat uncured composite laminate 240. Overhanging portions 257 are portions of flat uncured composite laminate 240 not in contact with mandrel 204 when flat uncured composite laminate 240 is placed in contact with web surface 206. In some illustrative examples, overhanging portions 257 can be referred to as cantilevered portions.

In some illustrative examples, flat uncured composite laminate 240 is transferred to mandrel 204 using vacuum chuck 265. In some illustrative examples, vacuum chuck 265 remains on flat uncured composite laminate 240 during forming against forming surface 230 of mandrel 204. In some illustrative examples, vacuum chuck remains on bent laminate 266 as number of flanges 293 are formed by forming assembly 276. In some illustrative examples, forming assembly 276 may be referred to as a composite forming assembly, a spar forming assembly, or a longitudinal composite forming assembly. Vacuum chuck 265 helps maintain tension in the composite laminate, flat uncured composite laminate 240 and bent laminate 266, during forming against forming surface 230. Thickness 267 of vacuum chuck 265 moves a neutral axis of bending to the interface between flat uncured composite laminate 240 and vacuum chuck 265.

Vacuum is applied to flat uncured composite laminate 240 to hold flat uncured composite laminate 240 against vacuum chuck 265 while pressure 264 is applied by presser foot 262. Vacuum chuck 265 is configured such that applying vacuum to flat uncured composite laminate 240 pulls the neutral axis to the intersection between flat uncured composite laminate 240 and vacuum chuck 265. Applying the vacuum to flat uncured composite laminate 240 keeps flat uncured composite laminate 240 in tension during forming of flat uncured composite laminate 240 against mandrel 204.

Pressure 264 is applied to flat uncured composite laminate 240 on web surface 206 of mandrel 204 to bend flat uncured composite laminate 240. In some illustrative examples, pressure 264 is locally applied over flat uncured composite laminate 240 over kink region 208 in web surface 206 of mandrel 204. In some illustrative examples, forming system 202 comprises presser foot 262 configured to apply pressure 264 locally over kink region 208 in web surface 206. Applying pressure 264 to flat uncured composite laminate 240 can be referred to as a first forming operation. Bend 268 is formed in the first forming operation.

By applying pressure 264 to flat uncured composite laminate 240 on mandrel 204, flat uncured composite laminate 240 is bent into bent laminate 266 with bend 268. Bend 268 matches kink region 208 in web surface 206. Bent laminate 266 has overhanging portions 257 supported by support brackets 232 and support brackets 236. Bend 268 forms an angle in between two portions in longitudinal direction 295 of composite structure 298. Bend 268 extends through web 291 and number of flanges 293.

Contact between bent laminate 266 and web surface 206 is maintained during a second forming operation. Contact between bent laminate 266 and web surface 206 is maintained by applying pressure to bent laminate 266. In some illustrative examples, forming system 202 comprises shim 270 having curvature 272 configured to maintain contact between a composite laminate, bent laminate 266, and web surface 206. Curvature 272 has kink region 274 matching kink region 208 of mandrel 204. In some illustrative examples, presser feet are used to maintain contact between bent laminate 266 and web surface 206.

Bent laminate 266 comprising plurality of composite plies 242 is moved on mandrel 204 into forming assembly 276. Bent laminate 266 is in contact with web surface 206 of mandrel 204. Bent laminate 266 comprises overhanging portions 257 overhanging mandrel 204.

Forming assembly 276 performs bending 292 of overhanging portions 257 of bent laminate 266 into contact with sides 220 of mandrel 204 to form composite structure 298. Composite structure 298 has bend 268 in web 291 of composite structure 298 in contact with forming surface 230 of mandrel 204 and number of flanges 293 in contact with sides 220 of mandrel 204. Bent laminate 266 comprises plurality of zero degree plies 244 having cuts 246 within desired distance 252 of bend 268.

Forming assembly 276 comprises presser 282 that applies pressure to bent laminate 266 over web surface 206. In some illustrative examples, presser 282 is planar 296, and shim 270 is positioned between presser 282 and bent laminate 266. In some illustrative examples, presser 282 takes the form of presser feet that can be adjusted to apply pressure to bent laminate 266 including bend 268.

Forming system 202 further comprises heater assembly 278 configured to heat bent laminate 266 for bending 292. In some illustrative examples, heater assembly 278 of forming assembly 276 is a non-contact heating method. In some illustrative examples, forming system 202 comprises heater assembly 278 configured to apply forced air heating 283 locally to composite material over kink region 208. In some illustrative examples, heater assembly 278 comprises one of IR heating or induction heating.

In some illustrative examples, heater assembly 278 comprises upper heater 284 and lower heater 286. In some illustrative examples, upper heater 284 heats an upper surface of bent laminate 266. In some illustrative examples, lower heater 286 heats under at least one of overhanging portions 257 of bent laminate 266.

In some illustrative examples, forming assembly 276 further comprises heating plates 285. Heating plates 285 heat bent laminate 266 in planar areas. Heating plates 285 can be used to heat bent laminate 266 outside of bend 268.

By bending 292 overhanging portions 257 of bent laminate 266 onto flange forming surfaces 210, number of flanges 293 of composite structure 298 are formed. In some illustrative examples, bending 292 overhanging portions 257 comprises sweeping 294 overhanging portions 257 downward onto sides 220 of mandrel 204.

Urging devices 280 of forming assembly 276 perform bending 292 of overhanging portions 257. Urging devices 280 can be formed of any desirable flexible or compressible material. Urging devices 280 comprise kink 290 matching kink region 208 of mandrel 204. Urging devices 280 may also be referred to as number of sweepers 287. Number of sweepers 287 has curvature 289 matching web surface 206 of mandrel 204. Urging devices 280 are configured to form bent laminate 266 downward against mandrel 204 without undesirably affecting bent laminate 266. In some illustrative examples, urging devices 280 take the form of bladders 288. Bladders 288 are flexible bladders configured to bend overhanging portions 257 downward without undesirably affecting bent laminate 266. Plurality of composite plies 242 are laid up on a layup tool to form flat uncured composite laminate 240. Plurality of composite plies 242 comprises composite plies having any desirable fiber orientations. The fiber orientations can be selected from zero degree, +/−45 degree, 90 degrees, or any other desirable fiber orientations. In some illustrative examples, plurality of composite plies 242 comprises a plurality of fiber orientations. Plurality of composite plies 242 comprises plurality of zero degree plies 244. Cuts 246 are formed in plurality of zero degree plies 244 within desired distance 252 of intended location 260 of bend 268 in plurality of composite plies 242 during lay-up.

In some illustrative examples, cuts 246 extend across the entirety of width 249 of plurality of zero degree plies 244. When cuts 246 extend across the entirety of width 249 of plurality of zero degree plies 244, plurality of zero degree plies 244 are discontinuous 248. In some illustrative examples, cuts 246 are only present in areas of plurality of composite plies 242 that will form number of flanges 293. In these illustrative examples, cuts 246 are not present in web 291 of composite structure 298. In some illustrative examples, cuts 246 are present in plurality of composite plies 242 in staggered fashion 250 through thickness 256. In some illustrative examples, cuts 246 are plurality of distances 254 from intended location 260.

Cuts 246 in plurality of zero degree plies 244 are staggered through thickness 256 of flat uncured composite laminate 240. Cuts 246 are staggered through thickness 256 so that successive zero degree plies in plurality of zero degree plies 244 are overlapped from layer to layer. In some illustrative examples, cuts 246 are staggered on both sides of a kink in mandrel 204 so that successive zero degree plies in plurality of zero degree plies 244 are overlapped from layer to layer. Cuts 246 are staggered so that even after gaps are formed in plurality of zero degree plies 244 during forming of bend 268 in web 291 and number of flanges 293, successive zero degree plies in plurality of zero degree plies 244 are overlapped from layer to layer.

Staggered fashion 250 of cuts 246 creates overlaps 299 of plurality of zero degree plies 244. Overlaps 299 of plurality of zero degree plies 244 over cuts 246 are configured such that a load is carried through bend 268 in composite structure 298. Overlaps 299 of plurality of zero degree plies 244 allows for a load to be transferred from a cut of cuts 246 to the next successive zero degree ply of plurality of zero degree plies 244. Staggering of cuts 246 allows for a load to be carried through bend 268 in composite structure 298 with cuts 246. Overlaps 299 are configured such that each successive zero degree ply of plurality of zero degree plies 244 still overlaps after gaps 297 are formed in plurality of zero degree plies 244 during bending.

Cuts 246 create cut fibers in each of plurality of zero degree plies 244. When cuts 246 are created in plurality of zero degree plies 244 during layup, the cut fibers in each zero degree ply will be abutting. In some illustrative examples, a cut of cuts 246 does not remove material from a respective zero degree ply of plurality of zero degree plies 244. A cut severs the fibers in the respective zero degree ply to cause the ply to be discontinuous 248.

Forming bend 268 into flat uncured composite laminate 240 causes gaps 297 within plurality of zero degree plies 244 with cuts 246. Gaps 297 will be present at cuts 246 in plurality of zero degree plies 244. The size of gaps 297 is different in number of flanges 293 than in web 291. Gaps 297 in web 291 will be smaller than gaps 297 in number of flanges 293. In some illustrative example, sizes of gaps 297 change in longitudinal direction 295 of composite structure 298. In some illustrative examples, gaps 297 closer to a kink in mandrel 204 are larger than gaps 297 farther from the kink. In some illustrative examples, when number of kinks 209 comprises two kinks, gaps 297 formed between the two kinks are larger than gaps formed near the respective kinks or outside of kink region 208.

In some illustrative examples, gaps 297 in number of flanges 293 have a “fan” or triangular shape through number of flanges 293. Each gap of gaps 297 increases in size moving away from web 291 in a flange of number of flanges 293. A portion of a gap near a respective corner forming edge, such as corner forming edge 212 or corner forming edge 214 will be smaller than the portion of the same gap moving down a respective side of sides 220 and away from web surface 206. In some illustrative examples, the increasing gap and the location of the neutral axis outside of flat uncured composite laminate 240 during bending causes evenly distributing compression load on the fibers regardless of the fiber orientation through at least the kink during the forming. In some illustrative examples, evenly distributing the compression load allows for forming with reducing wrinkling or no wrinkling.

Plurality of composite plies 242 is placed as flat uncured composite laminate 240 onto mandrel 204. Pressure 264 is applied to flat uncured composite laminate 240 on mandrel 204 to form plurality of composite plies 242 against web surface 206 and form bent laminate 266 having bend 268.

Pressure 264 is applied to portion 258 of flat uncured composite laminate 240 over kink region 208 in forming surface 230 of mandrel 204 to form bent laminate 266. Flat uncured composite laminate 240 comprising plurality of zero degree plies 244 discontinuous 248 along a respective length.

Bent laminate 266 and mandrel 204 are placed into forming assembly 276. Overhanging portions 257 of bent laminate 266 are bent into contact with sides 220 of mandrel 204 by forming assembly 276 to form composite structure 298. Composite structure 298 has bend 268 in web 291 of composite structure 298 in contact with forming surface 230 of mandrel 204 and number of flanges 293 in contact with sides 220 of mandrel 204 after forming number of flanges 293.

In some illustrative examples, applying pressure 264 comprises applying pressure 264 downward using presser foot 262 locally over kink region 208 in forming surface 230. In some illustrative examples, bending 292 overhanging portions 257 of bent laminate 266 comprises sweeping overhanging portions 257 downward onto flange forming surfaces 210 of mandrel 204.

In some illustrative examples, bending 292 overhanging portions 257 comprises sweeping 294 overhanging portions 257 downward using urging devices 280.

In some illustrative examples, placing flat uncured composite laminate 240 in contact with forming surface 230 comprises placing flat uncured composite laminate 240 in contact with web surface 206 of mandrel 204 and in contact with support brackets 232, 236 movably connected to flange forming surfaces 210 of mandrel 204 on either side of web surface 206 of mandrel 204. Support brackets 232, 236 can include support brackets near kink region 208 of mandrel 204. The support brackets near kink region 208 can remain on either side of web surface 206 after forming of flat uncured composite laminate 240 on web surface 206. The support brackets near kink region 208 can remain on either side of web surface 206 as bent laminate 266 on mandrel 204 is placed into forming assembly 276. In some illustrative examples, additional support brackets are present in non-kinked regions of mandrel 204. In some illustrative examples, the additional support brackets outside of kink region 208 can be removed from mandrel 204 prior to placing bent laminate 266 and mandrel 204 into forming assembly 276.

In some illustrative examples, bending 292 overhanging portions 257 of bent laminate 266 pushes support brackets 232, 236 downward on flange forming surfaces 210 of mandrel 204. In some illustrative examples, bent laminate 266 is locally heated at bend 268 using forced air heating 283 while bending 292 overhanging portions 257 of bent laminate 266.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, additional support brackets in addition to support brackets 232 and support brackets 236 can be present in non-kinked regions of mandrel 204. Support brackets 232 and support brackets 236 near kink region 208 can remain on either side of web surface 206 as bent laminate 266 on mandrel 204 is placed into forming assembly 276. In some illustrative examples, additional support brackets outside of kink region 208 can be removed from mandrel 204 prior to placing bent laminate 266 and mandrel 204 into forming assembly 276.

Composite structure 298 is a composite structure having a channel formed between web 291 and number of flanges 293. In some illustrative examples, composite structure 298 is a composite structure having a C cross-sectional shape. In some illustrative examples, composite structure 298 is a composite structure having a L cross-sectional shape. In some illustrative examples, composite structure 298 is a composite spar.

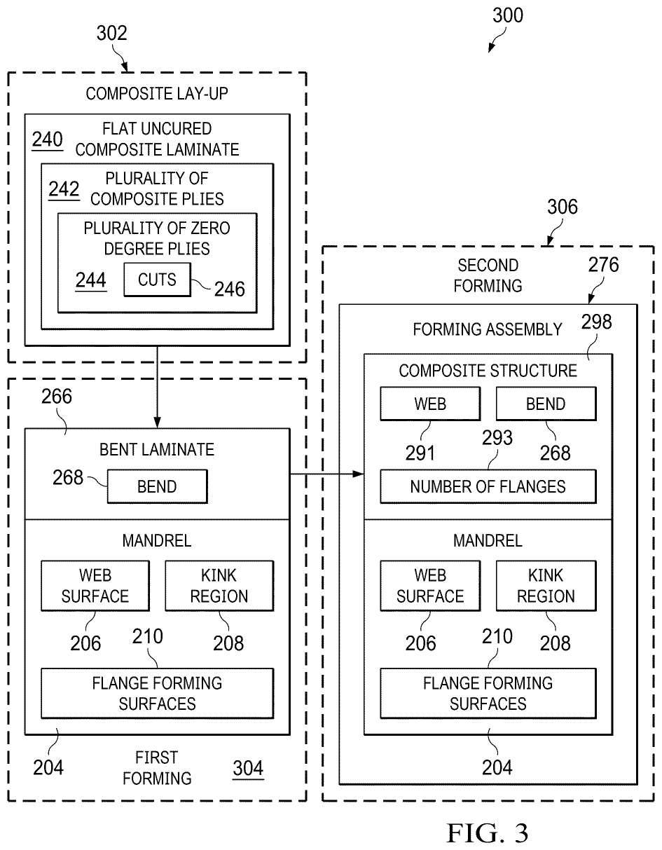

Turning now to FIG. 3, an illustration of a flowchart of a method of forming a composite structure with a number of bends is depicted in accordance with an illustrative embodiment. Method 300 is a method that can be performed in manufacturing environment 200 of FIG. 2 to form composite structure 298 using forming system 202.

In method 300, flat uncured composite laminate 240 is formed in composite lay-up 302. In composite lay-up 302, plurality of composite plies 242 is laid up to form flat uncured composite laminate 240. In this illustrative example, flat uncured composite laminate 240 comprises plurality of zero degree plies 244 with cuts 246. Cuts 246 across plurality of zero degree plies 244 allows for forming of flat uncured composite laminate 240 with reduced or prevented wrinkling.

After flat uncured composite laminate 240 is laid up in composite lay-up 302, flat uncured composite laminate 240 is placed onto mandrel 204. After placement of flat uncured composite laminate 240 on mandrel 204, first forming 304 is performed. During first forming 304, flat uncured composite laminate 240 is formed to web surface 206 with kink region 208. First forming 304 comprises applying a pressure to flat uncured composite laminate 240 over kink region 208 of mandrel 204 to form flat uncured composite laminate 240 into bent laminate 266 with bend 268. Bend 268 matches kink region 208 in mandrel 204. First forming 304 is performed on flat uncured composite laminate 240 to form a web portion.

After first forming 304, bent laminate 266 on mandrel 204 is transported to forming assembly 276. Second forming 306 is performed to bend bent laminate 266 onto flange forming surfaces 210. Forming assembly 276 performs second forming 306 on bent laminate 266 to create composite structure 298. Composite structure 298 comprises web 291 with bend 268 on web surface 206 of mandrel 204. Composite structure 298 further comprises number of flanges 293 in contact with flange forming surfaces 210 of mandrel 204. During second forming 306 forming assembly 276 sweeps overhanging portions of bent laminate 266 onto flange forming surfaces 210 of mandrel 204 to form number of flanges 293.

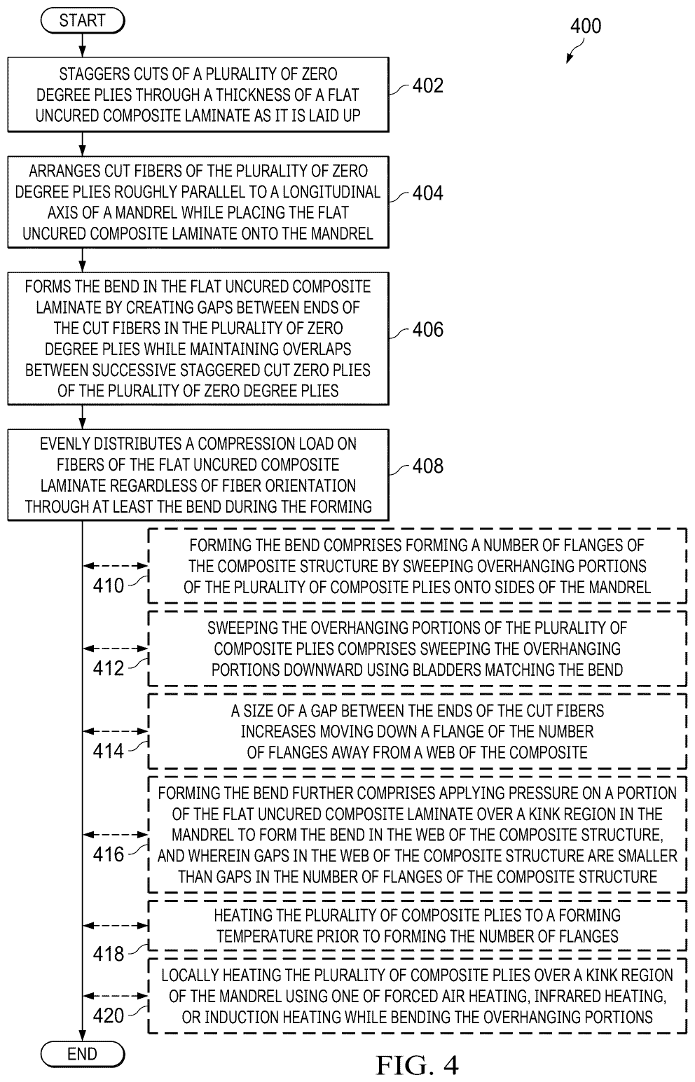

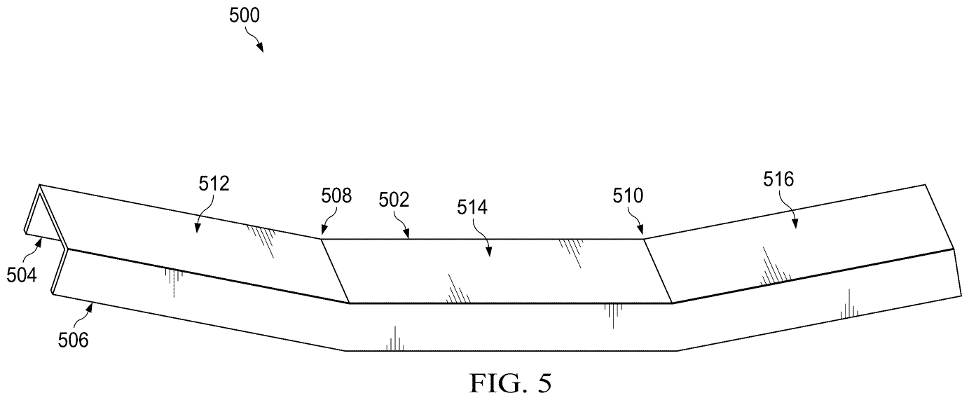

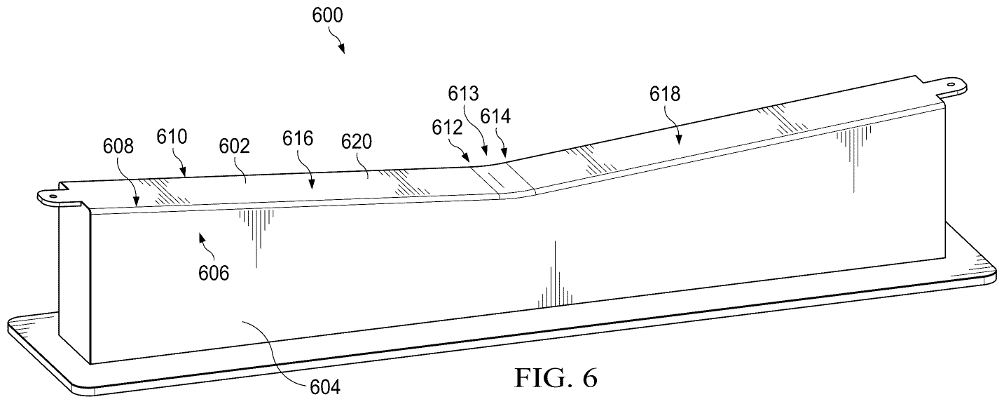

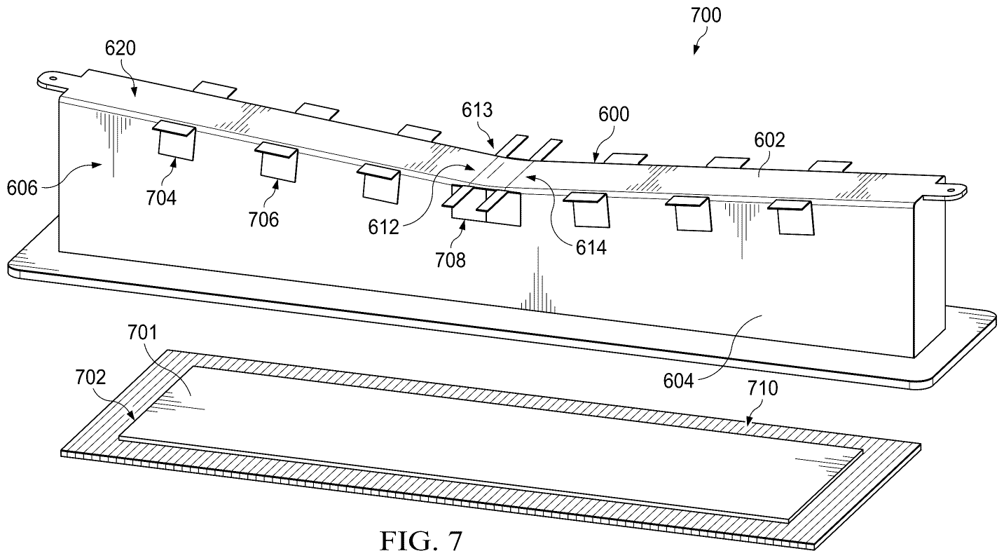

Turning now to FIG. 4, a flowchart of a method of forming a composite structure with a bend in a web and a number of flanges of the composite structure is depicted in accordance with an illustrative embodiment. Method 400 can be performed to form a composite structure of aircraft 100 of FIG. 1. Method 400 can be used to form composite structure 298 of FIG. 2. Method 1600 can be used to perform first forming 304 and second forming 306 of FIG. 3. Method 400 can be used to form composite structure 500 of FIG. 5. Method 400 can be performed using mandrel 600 of FIGS. 6-14. Method 400 can be performed on composite laminate 702 of FIGS. 7-14.

Method 400 staggers cuts of a plurality of zero degree plies through a thickness of a flat uncured composite laminate as it is laid up (operation 402). Method 400 arranges cut fibers of the plurality of zero degree plies roughly parallel to a longitudinal axis of a mandrel while placing the flat uncured composite laminate onto the mandrel (operation 404). Method 400 forms the bend in the flat uncured composite laminate by creating gaps between ends of the cut fibers in the plurality of zero degree plies while maintaining overlaps between successive staggered cut zero plies of the plurality of zero degree plies (operation 406). The overlaps between the successive staggered cut zero plies allow for transferring load to neighboring zero degree plies despite cuts present in the plies. Method 400 evenly distributes a compression load on fibers of the flat uncured composite laminate regardless of fiber orientation through at least the bend during the forming (operation 408).

In some illustrative examples, the flat uncured composite laminate comprises a plurality of composite plies including the plurality of zero degree plies. In some illustrative examples, forming the bend comprises forming a number of flanges of the composite structure by sweeping overhanging portions of the plurality of composite plies onto sides of the mandrel (operation 410). In some illustrative examples, sweeping the overhanging portions of the plurality of composite plies comprises sweeping the overhanging portions downward using bladders matching the bend (operation 412). In some illustrative examples, a size of a gap between the ends of the cut fibers increases moving down a flange of the number of flanges away from a web of the composite structure (operation 414). In some illustrative examples, a gap in a cut zero degree ply has a triangular or “fan” shape moving down a respective flange away from a web surface of the mandrel. In some illustrative examples, the size of the gap increases in a flange of the plurality of flanges moving in the direction of

In some illustrative examples, forming the bend further comprises applying pressure on a portion of the flat uncured composite laminate over a kink region in the mandrel to form the bend in the web of the composite structure, and wherein gaps in the web of the composite structure are smaller than gaps in the number of flanges of the composite structure (operation 416). In some illustrative examples, the bend is forming in the web prior to forming the bend in the flanges.

In some illustrative examples, method 400 heats the plurality of composite plies to a forming temperature prior to forming the number of flanges (operation 418). In some illustrative examples, a heating system uses heating plates in non-kinked regions to heat the plurality of composite plies. In some illustrative examples, the heating system comprises at least one non-contact method of heating.

In some illustrative examples, method 400 locally heating the plurality of composite plies over a kink region of the mandrel using one of forced air heating, infrared heating, or induction heating while bending the overhanging portions (operation 420).

Turning now to FIG. 5, an illustration of an isometric view of a composite structure with a number of bends is depicted in accordance with an illustrative embodiment. Composite structure 500 is a physical implementation of composite structure 298 of FIGS. 2 and 3. Composite structure 500 can be a component of aircraft 100 of FIG. 1.

Composite structure 500 comprises web 502, flange 504, and flange 506. Web 502 has bend 508 and bend 510. Bend 508 introduces an angle between web portion 512 and web portion 514. Bend 510 introduces an angle between web portion 514 and web portion 516.

Either of bend 508 or bend 510 can be created using a kink region of mandrel, such as kink region 613 of mandrel 600 in FIG. 6. In some illustrative examples, composite structure 500 can be formed on a mandrel having two kink regions, a first kink region to form bend 508 and a second kink region to form bend 510. Although the illustrative examples in FIGS. 6-14 show a single kink region, kink region 613, any desirable quantity of kink regions can be present in a mandrel to form a composite structure with a number of bends.

Further, each kink region of a mandrel can comprise any desirable quantity of kinks. For example, bend 508 can be formed by a kink region of a mandrel comprising only one kink. In other illustrative examples, bend 508 can be formed by a kink region of a mandrel comprising more than one kink. Kink region 613 is a physical implementation of a kink region with more than one kink present to form a single bend in a composite structure. Likewise, bend 510 can be formed by a kink region of a mandrel comprising only one kink. In other illustrative examples, bend 510 can be formed by a kink region of a mandrel comprising more than one kink.

Turning now to FIG. 6, an illustration of an isometric view of a mandrel with a number of kinks is depicted in accordance with an illustrative embodiment. Mandrel 600 is a physical implementation of mandrel 204 of FIGS. 2 and 3. Mandrel 600 can be used to form a composite component of aircraft 100 of FIG. 1. Mandrel 600 can be used to form a bend, such as bend 508 or bend 510 in composite structure 500 of FIG. 5.

Mandrel 600 comprises web surface 602 and sides 604. Sides 604 comprises flange forming surfaces 606. Flange forming surfaces 606 are on either side of web surface 602. Flange forming surfaces 606 are connected to web surface 602 by two corner forming edges, corner forming edge 608 and corner forming edge 610.

Web surface 602 has kink 612 and kink 614. Kink 612 and kink 614 introduce a change in angle of web surface 602. Kink 612 and kink 614 can be used to form a bend in a composite structure such as bend 508 or bend 510 in composite structure 500. Kink 612 and kink 614 introduce a change in angle between first section 616 and second section 618 of web surface 602. In some illustrative examples, kink 612, kink 614, and the region between kink 612 and kink 614 can be referred to as kink region 613.

Web surface 602 and flange forming surfaces 606 create forming surface 620. By applying pressure to a composite laminate on mandrel 600, the composite laminate is formed to forming surface 620.

In this illustrative example, kink 612 and kink 614 are a number of kinks used together to form a single bend in composite structure. In some other non-depicted illustrative examples, a single kink can be used to form a bend in a composite structure.

Turning now to FIG. 7, an illustration of an isometric view of a mandrel with a number of kinks and a flat uncured composite charge is depicted in accordance with an illustrative embodiment. View 700 is a view of mandrel 600 and composite laminate 702 to be formed on mandrel 600. Composite laminate 702 comprises flat uncured composite laminate 701.

Support brackets 704 are movably connected to flange forming surfaces 606 of mandrel 600. Support brackets 704 are present to support overhanging portions of composite laminate 702 on mandrel 600 during transfer into the forming machine.

As depicted, support brackets 704 comprise support brackets 706 outside of kink 612 and kink 614 and support brackets 708 near kink 612 and kink 614. Support brackets 704 are movably connected to mandrel 600 to provide for removal of support brackets 704. Support brackets 704 are movably connected to mandrel 600 so that at least one support bracket of support brackets 704 can be moved downward by sweeping composite laminate 702 onto flange forming surfaces 606 of mandrel 600 during the flange forming operation.

Flat uncured composite laminate 701 will be placed in contact with forming surface 620 of mandrel 600. In this illustrative example, flat uncured composite laminate 701 will be placed in contact with web surface 602 of mandrel 600. In some illustrative examples, placing flat uncured composite laminate 701 in contact with forming surface 620 comprises placing flat uncured composite laminate 701 in contact with web surface 602 of mandrel 600 and in contact with support brackets 704 movably connected to flange forming surfaces 606 of mandrel 600 on either side of web surface 602 of mandrel 600.

When flat uncured composite laminate 701 is initially placed on mandrel 600, flat uncured composite laminate 701 bridges across mandrel 600. Until pressure is applied to flat uncured composite laminate 701 over kink 612 and kink 614, flat uncured composite laminate 701 is not in contact with kink 612 and kink 614.

Flat uncured composite laminate 701 is present on vacuum chuck 710. Vacuum chuck 710 helps maintain tension in composite laminate 702 during forming against forming surface 620. A thickness of vacuum chuck 710 moves a neutral axis of bending to the interface between composite laminate 702 and vacuum chuck 710.

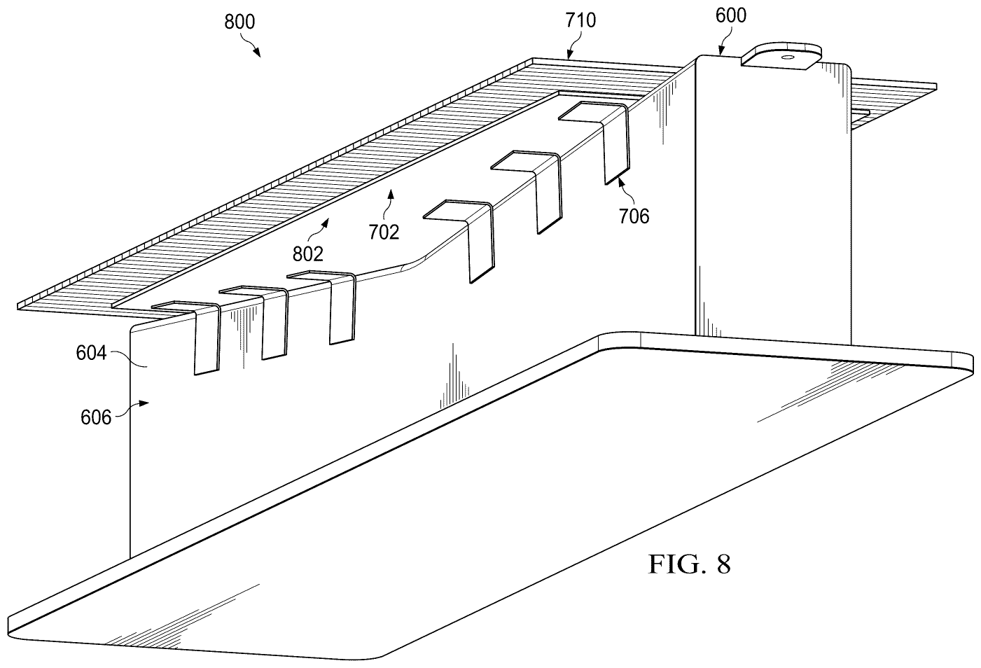

Turning now to FIG. 8, an illustration of an underside of an overhanging portion of a flat uncured composite charge on a mandrel with a number of kinks is depicted in accordance with an illustrative embodiment. In view 800 composite laminate 702 has been placed onto mandrel 600. In view 800, overhanging portion 802 of composite laminate 702 is supported by support brackets 704 movably connected to flange forming surfaces 606. Vacuum is applied to flat uncured composite laminate 702 to hold flat uncured composite laminate 702 against vacuum chuck 710.

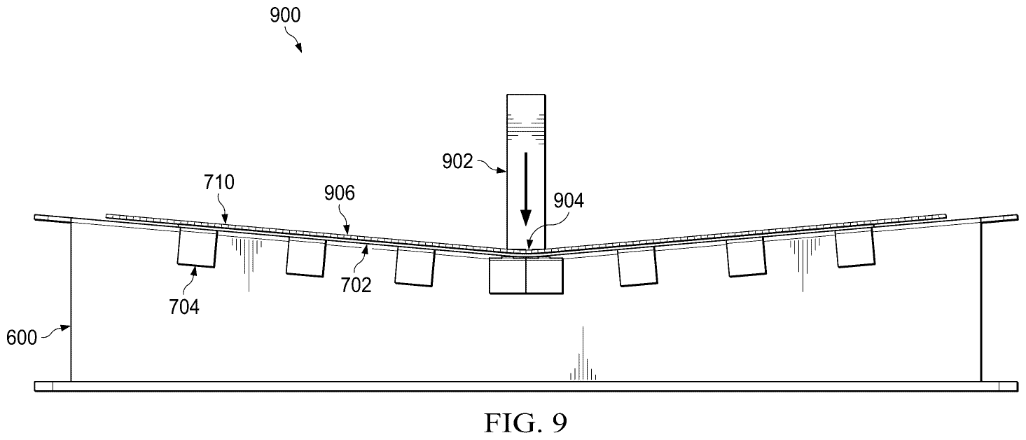

Turning now to FIG. 9, an illustration of a side view of a presser foot in contact with the flat uncured composite charge over the number of kinks of the mandrel is depicted in accordance with an illustrative embodiment. View 900 is a view of forming bend 904 into composite laminate 702 to form bent laminate 906. View 900 is a view of first forming 304 of FIG. 3.

In view 900, pressure is applied to a portion of composite laminate 702 over kink 612 and kink 614 in web surface 602 of mandrel 600 to form bent laminate 906 with bend 904. As depicted, applying the pressure comprises applying pressure downward using presser foot 902 locally over the portion of composite laminate 702 over kink 612 and kink 614 in forming surface 620 of mandrel 600.

Vacuum is applied to composite laminate 701 to hold composite laminate 701 against vacuum chuck 710 while pressure is applied by presser foot 902. Vacuum chuck 710 is configured such that applying vacuum to composite laminate 701 pulls the neutral axis to the intersection between composite laminate 701 and vacuum chuck 710. Applying the vacuum to composite laminate 701 keeps composite laminate 701 in tension during forming of composite laminate 701 against mandrel 600.

Although pressure is applied in view 900 directly over kink region 613, in other non-depicted examples additional forces can be applied in other regions of composite laminate 701. In some illustrative examples, optional constant or variable distributed forces can be applied to composite laminate 701 outside of kink region 613.

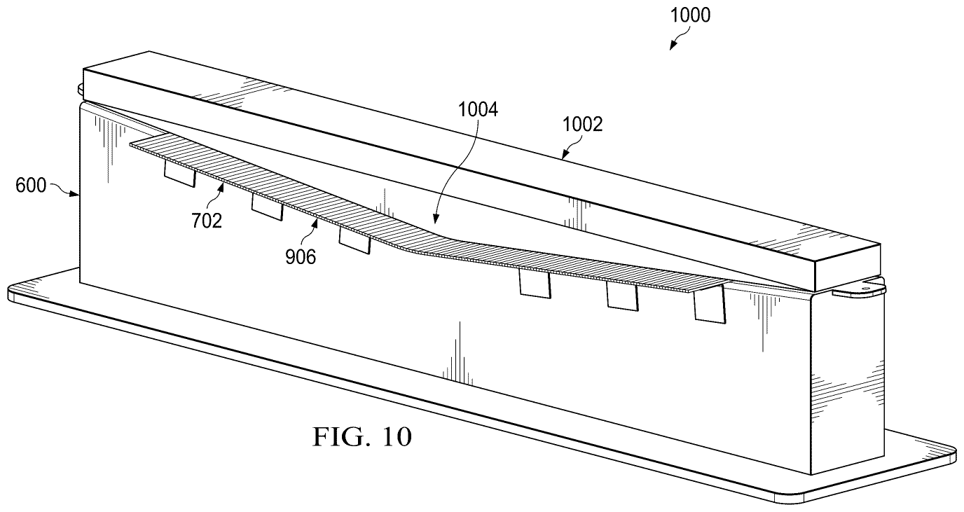

Turning now to FIG. 10, an illustration of an isometric view of a shim in contact with the bent composite charge on the mandrel is depicted in accordance with an illustrative embodiment. View 1000 is a view of composite laminate 702 in the form of bent laminate 906. Bent laminate 906 comprises bend 904.

A first forming has been performed on composite laminate 702 to form bend 904 in the portion of composite laminate 702 over web surface 602 of mandrel 600. Shim 1002 has been positioned over bent laminate 906. Shim 1002 has curvature 1004 with kink to maintain contact between bent laminate 906 and the forming surface 620 of mandrel 600 during bending of bent laminate 906 in a second forming operation.

Shim 1002 is one illustrative example to maintain contact between bent laminate 906 and forming surface 620 of mandrel 600. In other illustrative examples, separate presser feet can be used to maintain contact between bent laminate 906 and forming surface 620 of mandrel 600. In some illustrative examples, the presser feet are a portion of a forming assembly, such as forming assembly 276 of FIG. 2.

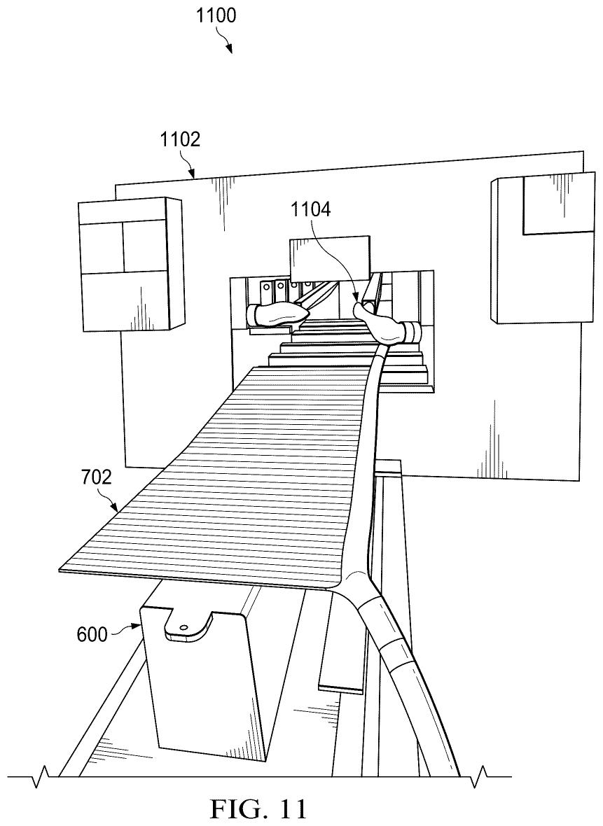

Turning now to FIG. 11, an illustration of the bent composite charge on the mandrel being introduced into the forming assembly is depicted in accordance with an illustrative embodiment. In view 1100, composite laminate 702 in the form of bent laminate 906 is present on mandrel 600. Bent laminate 906 on mandrel 600 is positioned to be placed into forming assembly 1102. Forming assembly 1102 comprises urging device 1104. Urging device 1104 may also be referred to as a “sweeper”.

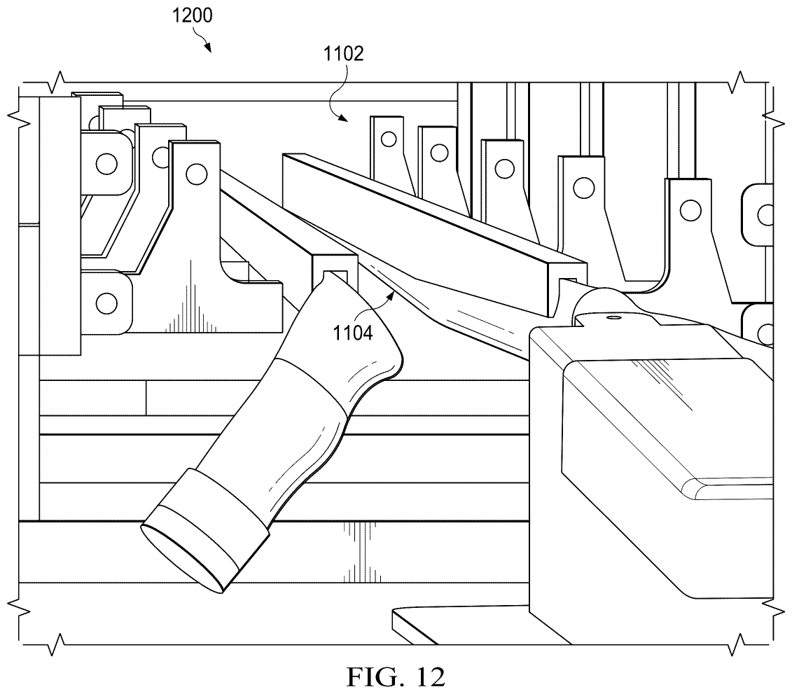

Turning now to FIG. 12, an illustration of an urging device of the forming assembly is depicted in accordance with an illustrative embodiment. In view 1200, urging device 1104 of forming assembly 1102 is visible. In this illustrative example, urging device 1104 takes the form of a flexible bladder. Urging device 1104 may also be referred to as a sweeper. Urging device 1104 can be formed of any desirable flexible or compressible material. Urging device 1104 is configured to form composite laminate 702 downward against mandrel 600 without undesirably affecting composite material 702.

Urging device 1104 will apply pressure downward on an overhanging portion of composite laminate 701 on one side of mandrel 600. Although not visible in view 1200, a second urging device can apply pressure downward to a second overhanging portion of composite laminate 701 on the opposite side of mandrel 600. Urging device 1104 and the second urging device will follow the contour of a web of composite laminate 701 including the bend.

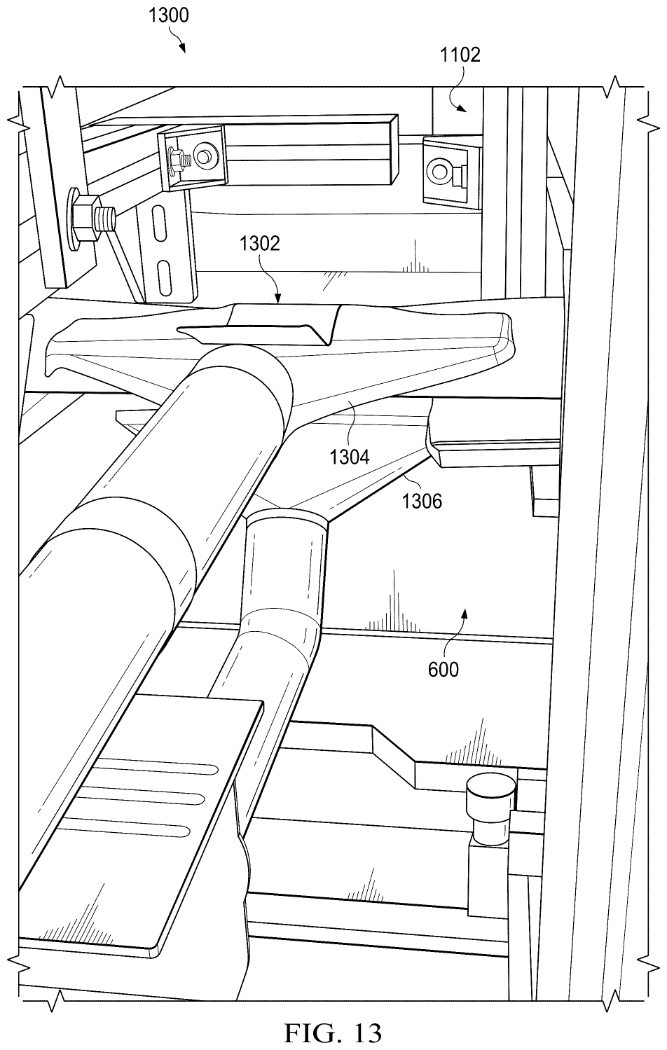

Turning now to FIG. 13, an illustration of a heater assembly of the forming assembly is depicted in accordance with an illustrative embodiment. Heater assembly 1302 of forming assembly 1102 is visible in view 1300. In this illustrative example, heater assembly 1302 comprises forced air heater 1304 and forced air heater 1306. Forced air heater 1304 is positioned to heat an upper portion of composite laminate 702. Forced air heater 1306 is positioned to heat an underside of the composite laminate 702. In other illustrative examples, heater assembly 1302 can take a form other than a forced air heater. In some illustrative examples, heater assembly 1302 comprises at least one of forced air heating, radiant heating, infrared heating, induction heating, or other non-contact heating.

Heater assembly 1302 is positioned in forming assembly 1102 to heat a portion of composite laminate 702 with bend 904. In some illustrative examples, heater assembly 1302 further comprises heating plates to heat portions of the composite laminate that are planar.

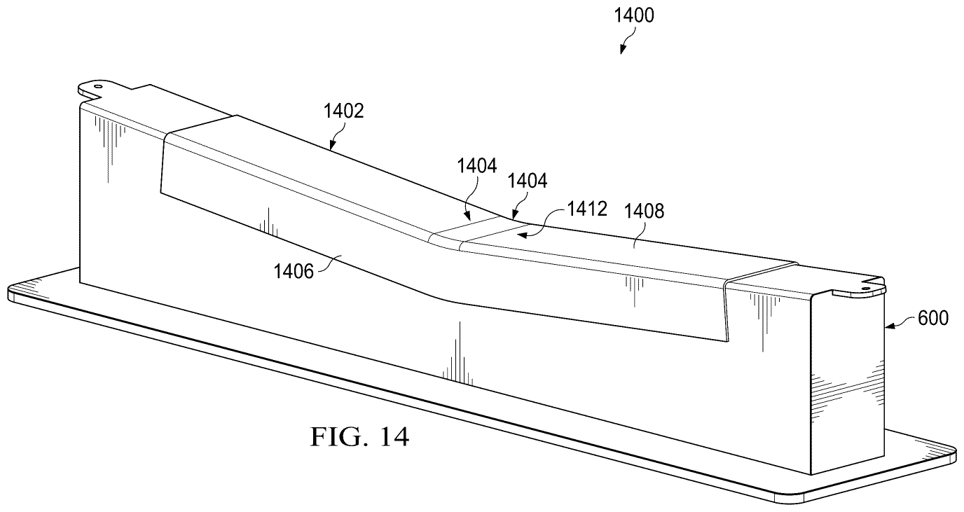

Turning now to FIG. 14, an illustration of an isometric view of a composite structure with a number of bends is depicted in accordance with an illustrative embodiment. In forming assembly 1102 of FIGS. 11-13, a second forming operation is performed to form composite laminate 702 into composite structure 1402. Composite structure 1402 exits forming assembly 1102 of FIGS. 11-13 on mandrel 600. In view 1400, web 1408 with bend region 1404 and number of flanges 1406 are visible. Bend region 1404 includes bend 1410, bend 1412, and the portion of web 1408 between bend 1410 and bend 1412.

Composite structure 1402 is a composite structure having a channel formed between web 1408 and number of flanges 1406. In some illustrative examples, composite structure 1402 is a composite structure having a C cross-sectional shape. In some illustrative examples, composite structure 1402 is a composite structure having a L cross-sectional shape.

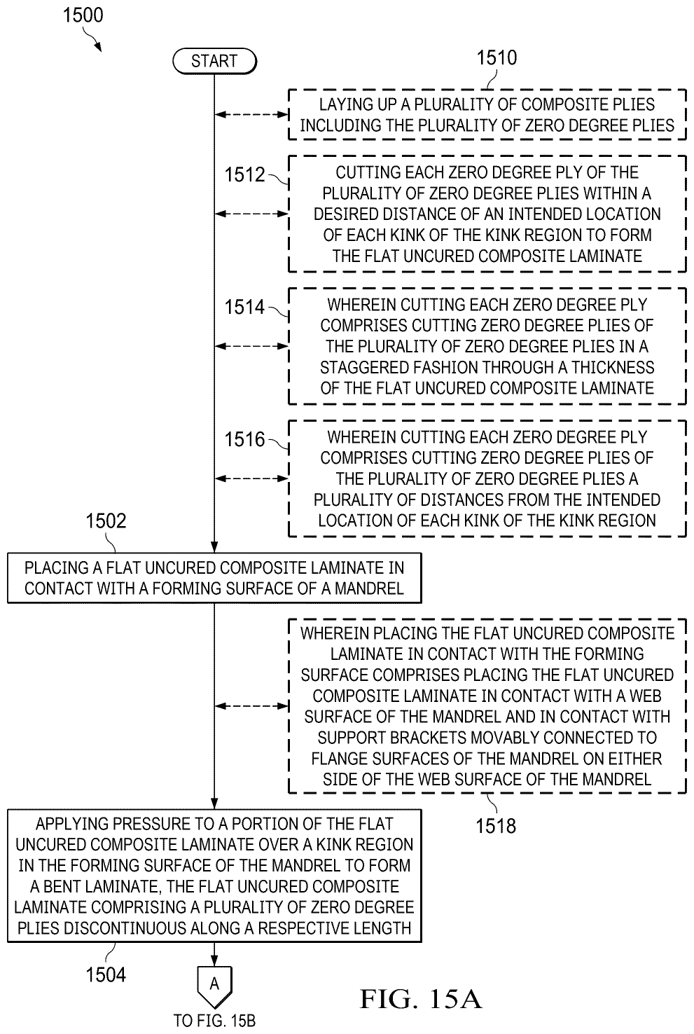

Turning now to FIGS. 15A and 15B, a flowchart of a method of forming a composite structure with a bend in a web and a number of flanges of the composite structure is depicted in accordance with an illustrative embodiment. Method 1500 can be performed to form a composite structure of aircraft 100 of FIG. 1. Method 1500 can be used to form composite structure 298 of FIG. 2. Method 1500 can be used to perform first forming 304 and second forming 306 of FIG. 3. Method 1500 can be used to form composite structure 500 of FIG. 5. Method 1500 can be performed using mandrel 600 of FIGS. 6-14. Method 1500 can be performed on composite laminate 702 of FIGS. 7-14.

A flat uncured composite laminate is placed in contact with a forming surface of a mandrel (operation 1502). Pressure is applied to a portion of the flat uncured composite laminate over a kink region in the forming surface of the mandrel to form a bent laminate (operation 1504). The bent laminate and the mandrel are placed into a forming assembly (operation 1506). Overhanging portions of the bent laminate are bent into contact with sides of the mandrel by the forming assembly to form the composite structure, the composite structure having the bend in a web of the composite structure in contact with the forming surface of the mandrel and number of flanges in contact with the sides of the mandrel (operation 1508). Afterwards, method 1500 terminates.

In some illustrative examples, method 1500 lays up a plurality of composite plies including the plurality of zero degree plies (operation 1510). In some illustrative examples, method 1500 cuts each zero degree ply of the plurality of zero degree plies during layup. In some illustrative examples, method 1500 cuts each zero degree ply of the plurality of zero degree plies in regions that will become number of flanges in the composite structure. In some illustrative examples, method 1500 cuts each zero degree ply of the plurality of zero degree plies within a desired distance of an intended location of each kink of the kink region to form the flat uncured composite laminate (operation 1512). In some illustrative examples, method 1500 cuts each zero degree ply of the plurality of zero degree plies across its width within a desired distance of an intended location of the kink to form the flat uncured composite laminate.

In some illustrative examples, cutting each zero degree ply comprises cutting zero degree plies of the plurality of zero degree plies in a staggered fashion through a thickness of the flat uncured composite laminate (operation 1514). By cutting the plurality of zero degree plies in a staggered fashion, mechanical properties are not undesirably affected in the regions of the cuts.

In some illustrative examples, cutting each zero degree ply comprises cutting zero degree plies of the plurality of zero degree plies a plurality of distances from the intended location of each kink of the kink region (operation 1516). The plurality of distances distributes the effects of the cuts across a larger distance. The plurality of distances are present so that mechanical properties are not undesirably affected in the regions of the cuts.

In some illustrative examples, placing the flat uncured composite laminate in contact with the forming surface comprises placing the flat uncured composite laminate in contact with a web surface of the mandrel and in contact with support brackets movably connected to flange forming surfaces of the mandrel on either side of the web surface of the mandrel (operation 1518). In some illustrative examples, the support brackets can be movably connected by being magnetically connected to the flange forming surfaces. In some illustrative examples, the support brackets are present on the sides of the kink of the mandrel. In some illustrative examples, additional support brackets can be movably connected to the flange forming surfaces outside of the kink.

In some illustrative examples, applying the pressure comprises applying the pressure downward using a presser foot locally over the portion of the flat uncured composite laminate over the kink region of the forming surface (operation 1520). In some illustrative examples, the presser foot can gradually apply pressure to the composite laminate over the kink in the mandrel.

In some illustrative examples, method 1500 applies a vacuum to the flat uncured composite laminate to hold the flat uncured composite laminate against a vacuum chuck while the pressure is applied (operation 1521). A thickness of the vacuum chuck moves a neutral axis of bending to the interface between the composite laminate and the vacuum chuck.

In some illustrative examples, bending overhanging portions of the bent laminate comprises sweeping the overhanging portions downward onto flange forming surfaces of the mandrel (operation 1522). In some illustrative examples, sweeping the overhanging portions comprises sweeping the overhanging portions downward using flexible bladders (operation 1524). In some illustrative examples, bending overhanging portions of the bent laminate pushes the support brackets downward on the flange forming surfaces of the mandrel (operation 1526). In some illustrative examples, the support brackets pushed downward can be present near the kink. In some illustrative examples, additional support brackets outside of the kink can be removed from the flange forming surfaces prior to bending overhanging portions downward.

In some illustrative examples, method 1500 locally heats the bent laminate at the kink using forced air heating while bending the overhanging portions of the bent laminate (operation 1528). In other illustrative examples, method 1500 locally heats the bent laminate at the kink using other non-contact methods such as IR heating or induction heating. In some illustrative examples, method 1500 heats the bent laminate in areas outside of the kink using heated plates.

In some illustrative examples, method 1500 applies pressure to the bent laminate using a shim having a curvature with the kink region to maintain contact between the bent laminate and the forming surface during the bending (operation 1530). In these illustrative examples, the shim can provide equal pressure application from a planar presser foot to the bent laminate with the kink. In some illustrative examples, method 1500 applies pressure to the bent laminate using presser feet to maintain contact between the bent laminate and the web surface during the bending.

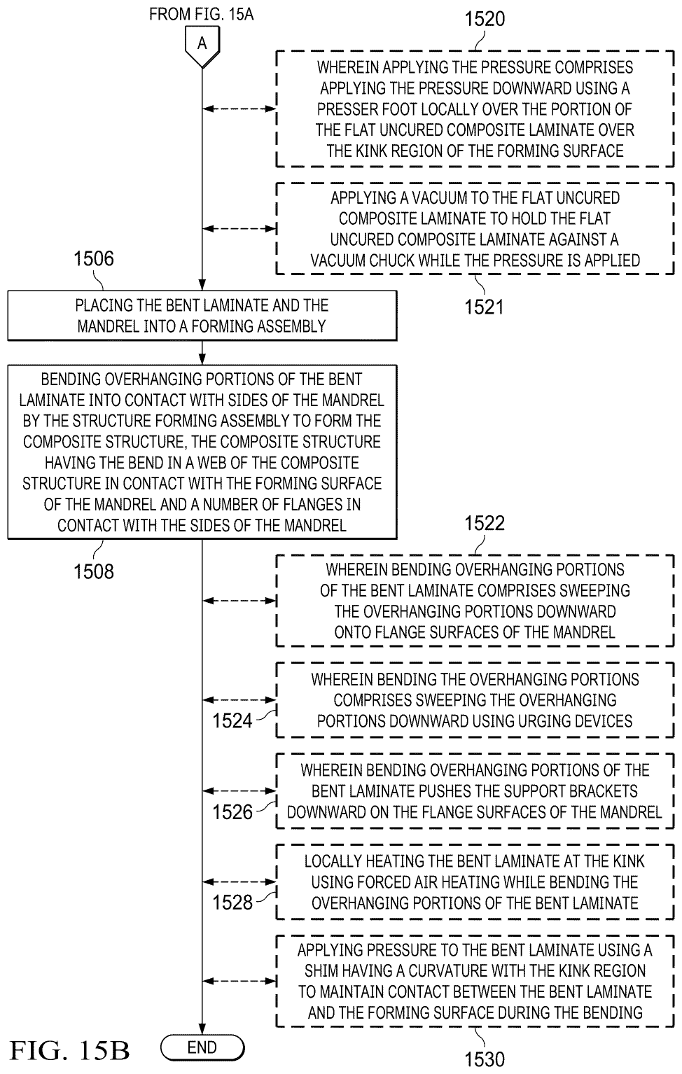

Turning now to FIG. 16, a flowchart of a method of forming a composite structure with a bend in a web and a number of flanges of the composite structure is depicted in accordance with an illustrative embodiment. Method 1600 can be performed to form a composite structure of aircraft 100 of FIG. 1. Method 1600 can be used to form composite structure 298 of FIG. 2. Method 1600 can be used to perform first forming 304 and second forming 306 of FIG. 3. Method 1600 can be used to form composite structure 500 of FIG. 5. Method 1600 can be performed using mandrel 600 of FIGS. 6-14. Method 1600 can be performed on composite laminate 702 of FIGS. 7-14.

Method 1600 moves a bent laminate comprising a plurality of composite plies on a mandrel into a forming assembly, the bent laminate in contact with a web surface of the mandrel and comprising overhanging portions overhanging the mandrel, the web surface comprising a kink region comprising a number of kinks forming an angle between a first section and a second section of the web surface in a longitudinal direction of the mandrel (operation 1602). Method 1600 bends the overhanging portions of the bent laminate into contact with sides of the mandrel by the forming assembly to form the composite structure, the composite structure having the bend in a web of the composite structure in contact with the forming surface of the mandrel and number of flanges in contact with the sides of the mandrel, the bent laminate comprising a plurality of zero degree plies having cuts within a desired distance of each kink of the number of kinks (operation 1604).

In some illustrative examples, method 1600 lays up the plurality of composite plies on a layup tool (operation 1606). In some illustrative examples, method 1600 forms the cuts into zero degree plies of the plurality of zero degree plies within a desired distance of the intended location of each kink of the number of kinks in the plurality of composite plies during lay-up (operation 1608).

In some illustrative examples, method 1600 places the plurality of composite plies as a flat uncured composite laminate onto the mandrel (operation 1610). In some illustrative examples, method 1600 applies pressure to the flat uncured composite laminate on the mandrel to form the plurality of composite plies against the web surface and form the bent laminate having a bend (operation 1612).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1510 through operation 1530 may be optional. For example, operation 1606 through operation 1612 may be optional.

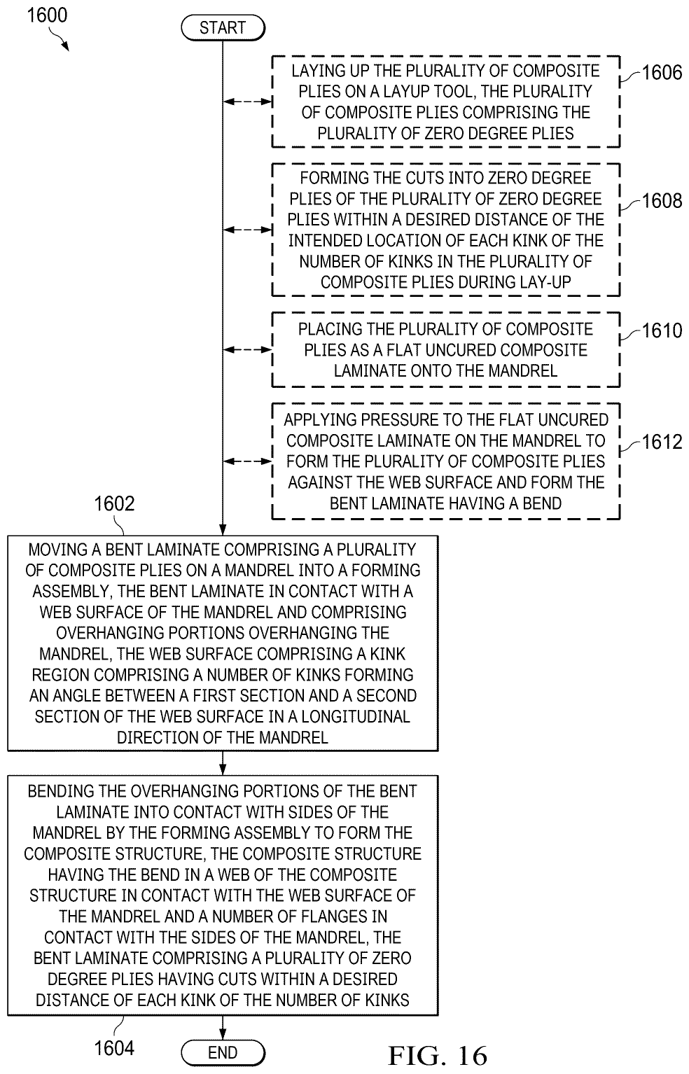

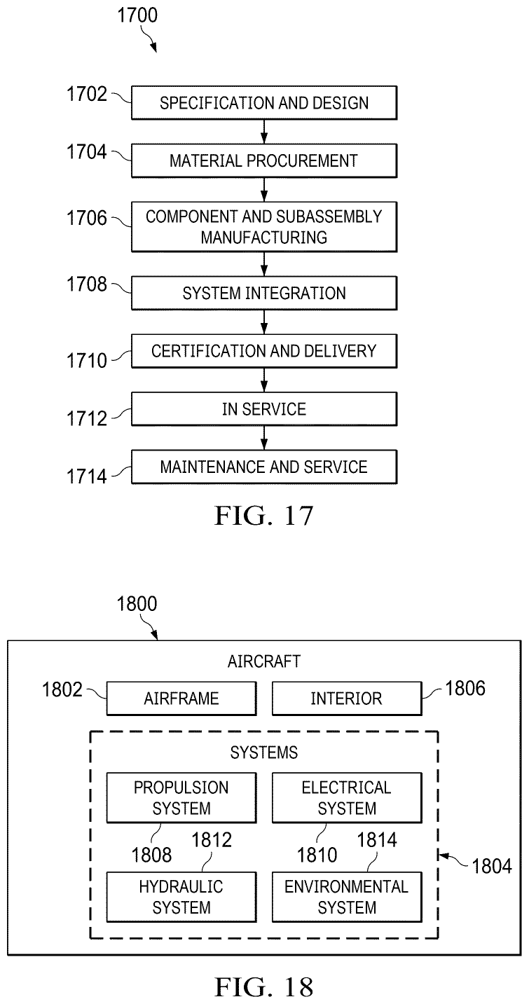

Illustrative embodiments of the present disclosure may be described in the context of aircraft manufacturing and service method 1700 as shown in FIG. 17 and aircraft 1800 as shown in FIG. 18. Turning first to FIG. 17, an illustration of an aircraft manufacturing and service method in a form of a block diagram is depicted in accordance with an illustrative embodiment. During pre-production, aircraft manufacturing and service method 1700 may include specification and design 1702 of aircraft 1800 in FIG. 18 and material procurement 1704.

During production, component and subassembly manufacturing 1706 and system integration 1708 of aircraft 1800 takes place. Thereafter, aircraft 1800 may go through certification and delivery 1710 in order to be placed in service 1712. While in service 1712 by a customer, aircraft 1800 is scheduled for routine maintenance and service 1714, which may include modification, reconfiguration, refurbishment, or other maintenance and service.

Each of the processes of aircraft manufacturing and service method 1700 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 18, an illustration of an aircraft in a form of a block diagram is depicted in which an illustrative embodiment may be implemented. In this example, aircraft 1800 is produced by aircraft manufacturing and service method 1700 of FIG. 17 and may include airframe 1802 with plurality of systems 1804 and interior 1806. Examples of systems 1804 include one or more of propulsion system 1808, electrical system 1810, hydraulic system 1812, and environmental system 1814. Any number of other systems may be included.

Apparatuses and methods embodied herein may be employed during at least one of the stages of aircraft manufacturing and service method 1700. One or more illustrative embodiments may be manufactured or used during at least one of component and subassembly manufacturing 1706, system integration 1708, in service 1712, or maintenance and service 1714 of FIG. 17.

The illustrative examples present methods and apparatuses to create a composite structure with at least one kink. The illustrative examples can be used to manufacture a composite structure with multiple kinks. In the illustrative examples, discontinuous zero plies mitigate tension during forming of the flange.

In the illustrative examples, an uncured composite laminate is placed on the kinked web of a mandrel and support brackets. The flat charge is formed to the web surface kink before flange forming. Pressure is applied on the web surface during forming. In some illustrative examples, forming bladders match the kink. In some illustrative examples, pressure is gradually added to bend/stretch laminate into shape without wrinkling. The illustrative examples are performed at room temperature.

The cut zeros are positioned in a desired portion for a kink in the layup. A kink is formed in the flat laminate in a first forming process. In the illustrative examples, at least a portion of the zero degree plies in the composite laminate are cut in a staggered pattern. In some illustrative examples, cuts in the zero degree plies extend across the whole width of a respective zero ply, including portions that will form a number of flanges and across the web. In some illustrative examples, cuts are present only in the number of flanges of a respective zero ply. In some illustrative examples, at least one zero degree ply in the stack is not cut to keep the laminate from over stretching.

In some illustrative examples, a web shim is placed on the kinked laminate to evenly distribute compression load through at least the kink. In some illustrative examples, the web shim is created to fill in the gap between the kinked web surface and a flat web pressure application of the forming assembly. In some illustrative examples, the web shim is made to match the kink. The web shim holds the web of the composite laminate in place during forming. In other illustrative examples, presser feet can be used.

The kinked laminate on the mandrel is moved into a forming assembly. The forming assembly has urging devices that match the kink of the mandrel. In some illustrative examples, the urging devices take the form of bladders that match the kink of the mandrel. In some illustrative examples, some of the support brackets are removed prior to forming the number of flanges in the forming machine.

In some illustrative examples, the kinked laminate is heated to forming temperature using heat plates for the non-kinked areas. In some illustrative examples, the kinked areas of the laminate are heated by non-contact methods such as forced air heaters, IR heating, or induction heating.

In some illustrative examples, non-contact heaters are aimed at both the top and bottom surfaces of the composite laminate during the second forming operation. In some illustrative examples, non-contact heaters are aimed at both the top and bottom surfaces of the composite laminate and both move with the laminate as the number of flanges are formed. The top heater has an attachment to spread the heat over the entire kink forming area.

In these illustrative examples, the nozzles of a forced air heater are aimed at the kinked area of the composite laminate. The non-contact heater, such as a forced air heater can be attached to the moving portion of the forming assembly such that the heater is continuously aimed at a portion of the composite laminate that is being formed.

In the illustrative examples, the flange portion of the composite structure is formed using sweeping by the forming assembly. Support brackets are used to support the composite laminate during the second forming and transfer into the forming machine.

The support brackets can be held to the mandrel using any desirable movable method. In some illustrative examples, the support brackets are held to the mandrel using strong magnets and slide down the side of the mandrel as the laminate is formed, continuing to support the laminate through the forming process.

In some illustrative examples, longer support brackets under the kinked areas are kept in place and are slid down the mandrel sides during forming by the laminate. In some illustrative examples, the support brackets under the non-kinked areas are removed and a heat plate is slid under the laminate to heat the material to forming temperature.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method of forming a composite structure with a bend in a web and a number of flanges of the composite structure, the method comprising:
placing a flat uncured composite laminate in contact with a forming surface of a mandrel;
applying pressure to a portion of the flat uncured composite laminate over a kink region in the forming surface of the mandrel to form a bent laminate, the flat uncured composite laminate comprising a plurality of zero degree plies discontinuous along a respective length;
placing the bent laminate and the mandrel into a forming assembly; and
bending overhanging portions of the bent laminate into contact with sides of the mandrel by the forming assembly to form the composite structure, the composite structure having the bend in a web of the composite structure in contact with the forming surface of the mandrel and a number of flanges in contact with the sides of the mandrel.

2. The method of claim 1, wherein applying the pressure comprises applying the pressure downward using a presser foot locally over the portion of the flat uncured composite laminate over the kink region of the forming surface, and further comprising:
applying a vacuum to the flat uncured composite laminate to hold the flat uncured composite laminate against a vacuum chuck while the pressure is applied.

3. The method of claim 1, wherein bending the overhanging portions of the bent laminate comprises sweeping the overhanging portions downward onto flange forming surfaces of the mandrel.

4. The method of claim 1, wherein sweeping the overhanging portions comprises sweeping the overhanging portions downward using urging devices.

5. The method of claim 1, wherein placing the flat uncured composite laminate in contact with the forming surface comprises placing the flat uncured composite laminate in contact with a web surface of the mandrel and in contact with support brackets movably connected to flange forming surfaces of the mandrel on either side of the web surface of the mandrel.

6. The method of claim 5, wherein bending overhanging portions of the bent laminate pushes the support brackets downward on the flange forming surfaces of the mandrel.

7. The method of claim 1 further comprising:
laying up a plurality of composite plies including the plurality of zero degree plies; and
cutting each zero degree ply of the plurality of zero degree plies across its width within a desired distance of an intended location of each kink of the kink region to form the flat uncured composite laminate.

8. The method of claim 7, wherein cutting each zero degree ply comprises cutting zero degree plies of the plurality of zero degree plies in a staggered fashion through a thickness of the flat uncured composite laminate.

9. The method of claim 7, wherein cutting each zero degree ply comprises cutting zero degree plies of the plurality of zero degree plies a plurality of distances from the intended location of each kink of the kink region.

10. The method of claim 1 further comprising:
locally heating the bent laminate at the kink region using forced air heating while bending the overhanging portions of the bent laminate.

11. The method of claim 1 further comprising:
applying pressure to the bent laminate using a shim having a curvature with the kink region to maintain contact between the bent laminate and the forming surface during the bending.

12. A forming system comprising:
a mandrel comprising a web surface with a kink region and flange forming surfaces on either side of the web surface, the flange forming surfaces connected to the web surface by two corner forming edges.

13. The forming system of claim 12, further comprising:
support brackets movably connected to the flange forming surfaces of the mandrel.

14. (canceled)

15. The forming system of claim 12 further comprising:
a presser foot configured to apply pressure locally over the kink region in the web surface.

16. (canceled)

17. The forming system of claim 12 further comprising:
a number of sweepers having a curvature matching the web surface of the mandrel.

18-19. (canceled)

20. A method of forming a composite structure with a bend in a web and a number of flanges of the composite structure, the method comprising:
moving a bent laminate comprising a plurality of composite plies on a mandrel into a forming assembly, the bent laminate in contact with a web surface of the mandrel and comprising overhanging portions overhanging the mandrel, the web surface comprising a kink region comprising a number of kinks forming an angle between a first section and a second section of the web surface in a longitudinal direction of the mandrel; and
bending the overhanging portions of the bent laminate into contact with sides of the mandrel by the forming assembly to form the composite structure, the composite structure having the bend in a web of the composite structure in contact with the web surface of the mandrel and a number of flanges in contact with the sides of the mandrel, the bent laminate comprising a plurality of zero degree plies having cuts within a desired distance of each kink of the number of kinks.

21. The method of claim 20 further comprising:
laying up the plurality of composite plies on a layup tool, the plurality of composite plies comprising the plurality of zero degree plies; and
forming cuts into zero degree plies of the plurality of composite plies within a desired distance of an intended location of each kink of the number of kinks in the plurality of composite plies during lay-up.

22. The method of claim 21 further comprising:
placing the plurality of composite plies as a flat uncured composite laminate onto the mandrel; and
applying pressure to the flat uncured composite laminate on the mandrel to form the plurality of composite plies against the web surface and form the bent laminate having a bend.

23. A method of forming a bend in a composite structure, the method comprising:
staggering cuts of a plurality of zero degree plies through a thickness of a flat uncured composite laminate as it is laid up;
arranging cut fibers of the plurality of zero degree plies roughly parallel to a longitudinal axis of a mandrel while placing the flat uncured composite laminate onto the mandrel;
forming the bend in the flat uncured composite laminate by creating gaps between ends of the cut fibers in the plurality of zero degree plies while maintaining overlaps between successive staggered cut zero plies of the plurality of zero degree plies; and
evenly distributing a compression load on fibers of the flat uncured composite laminate regardless of fiber orientation through at least the bend during the forming.

24. The method of claim 23, wherein the flat uncured composite laminate comprises a plurality of composite plies including the plurality of zero degree plies, and wherein forming the bend comprises forming a number of flanges of the composite structure by sweeping overhanging portions of the plurality of composite plies onto sides of the mandrel.

25. The method of claim 24, wherein sweeping the overhanging portions of the plurality of composite plies comprises sweeping the overhanging portions downward using bladders matching the bend.

26. The method of claim 24, wherein a size of a gap between the ends of the cut fibers increases moving down a flange of the number of flanges away from a web of the composite structure.

27. The method of claim 26, wherein forming the bend further comprises applying pressure on a portion of the flat uncured composite laminate over a kink region in the mandrel to form the bend in the web of the composite structure, and wherein gaps in the web of the composite structure are smaller than gaps in the number of flanges of the composite structure.

28. The method of claim 24 further comprising:
heating the plurality of composite plies to a forming temperature prior to forming the number of flanges.

29. The method of claim 28 further comprising:
locally heating the plurality of composite plies over a kink region of the mandrel using one of forced air heating, infrared heating, or induction heating while bending the overhanging portions.
